(19) United States
(12) Patent Application Publication
(10) Pub. No.: US 2015/0208371 A1
(43) Pub. Date: Jul. 23, 2015

(54) APPARATUS FOR DEVICE TO DEVICE SYNCHRONIZATION SIGNAL TRANSMISSION ON LTE DEVICE TO DEVICE COMMUNICATION

(71) Applicant: Humax Holdings Co., Ltd., Yongin-si (KR)

(72) Inventors: Alex Chungku Yie, Incheon (KR); Yongjae Lee, Seongnam-si (KR); Jun Bae Ahn, Gwangju-si (KR)

(21) Appl. No.: 14/603,299

(22) Filed: Jan. 22, 2015

(30) Foreign Application Priority Data
Jan. 23, 2014 (KR) 10-2014-0008371
May 16, 2014 (KR) 10-2014-0058952
May 16, 2014 (KR) 10-2014-0058953
May 16, 2014 (KR) 10-2014-0058954
Nov. 14, 2014 (KR) 10-2014-0158950
Nov. 19, 2014 (KR) 10-2014-0161846
Nov. 19, 2014 (KR) 10-2014-0161847
Nov. 20, 2014 (KR) 10-2014-0162699
Jan. 22, 2015 (KR) 10-2015-0010854

(51) Int. Cl. H04W 56/00; H04L 5/00; H04W 72/02; H04J 11/00; H04W 4/00; H04W 72/04

(52) U.S. Cl. CPC H04W 56/001; H04W 4/008; H04W 72/048; H04W 72/02; H04J 11/003; H04L 5/0007; H04J 2011/0096

(57) ABSTRACT

The present invention relates to an apparatus for device to device synchronization signal transmission on LTE device to device communication. That is, the present invention relates to an apparatus for device to device synchronization signal transmission on LTE device to device communication which periodically or aperiodically transmits a synchronization signal to detect an interference with the other terminal. The apparatus for device to device synchronization signal transmission on LTE device to device communication uses any one of a periodic transmission scheme, an aperiodic transmission scheme, a continuous transmission scheme, a transmission stopping scheme so as to perform the device to device communication with the other terminal to determine a transmission policy on a device to device synchronization signal.

### BACKGROUND OF THE INVENTION

1. Field of the Invention

Exemplary embodiments of the present invention relate to an apparatus for device to device synchronization signal transmission on LTE device to device communication, and more particularly, to synchronization signal transmission used in device to device communication. That is, Exemplary embodiments of the present invention relate to an apparatus for device to device synchronization signal transmission on LTE device to device communication which periodically or aperiodically transmits a synchronization signal to detect interference with the other terminal.

2. Description of the Related Art

A wireless communication technology uses various standards and protocols to transmit data between a base station and a terminal. As a modulation technology for wireless communication, orthogonal frequency-division multiplexing (OFDM) for high speed transmission may be used.

An example of the standards and protocols using the OFDM may include third generation partnership project (3GPP), long term evolution (LTE), institute of electrical and electronics engineers (IEEE) 802.16 and IEEE 802.11 standards, and the like.

In the 3GPP LTE system, a base station may be a combination of an evolved universal terrestrial radio access network (E-UTRAN) Node Bs (further, generally marked by evolved Node Bs, advanced Node Bs, eNodeBs, or eNBs) and radio network controller (RNC), which communicate with a terminal known as user equipment (UE). In the IEEE 802.16, the base station may be called as a base station (BS). In the IEEE 802.11, the base station may be referred to as a WiFi wireless access point (WAP).

At present, device to device communication generally uses a base station. The reason is that the base station performs scheduling of radio resources to increase device to device communication efficiency while reducing a load of the terminal. However, for the reason of a short device to device distance, multiplexing of the radio resources, or the like, the device to device communication is performed without passing through the base station to increase efficiency of the communication system. Therefore, research for increasing the device to device communication efficiency has been conducted.

As an example of the research, Korean Patent Laid-Open Publication No. 10-2013-0070661 discloses a method for controlling device to device communication. To enable the method effectively allocate resources for device to device communication, the base station receives positional information of each device and allocates resources for device to device communication according to a method for allocating selected resources.

Meanwhile, in addition to the foregoing resource allocation, there is a need to establish device to device synchronization for the device to device communication. For this purpose, devices may transmit and receive time information to and from each other. However, the existing method has a problem in that it takes much time to establish synchronization due to latency which is caused by coding and transmitting and receiving processes, a delay which is caused by an increase in complexity of a network, and the like.

Therefore, there is a need to develop a method for efficiently transmitting a device to device synchronization signal for device to device communication.

### RELATED ART DOCUMENT

### Patent Document

Korean Patent Laid-Open Publication No. 10-2013-0070661 (Jun. 28, 2013)

### SUMMARY OF THE INVENTION

An object of the present invention relates to provide an apparatus for device to device synchronization signal transmission on LTE device to device communication which transmits as synchronization signal used in the device to device communication.

Another object of the present invention is to provide an apparatus for device to device synchronization signal transmission on LTE device to device communication which effectively uses an wireless channel by periodically or aperiodically transmitting the synchronization signal to detect interference with the other terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for device to device synchronization signal transmission on LTE device to device communication includes: an RF unit that transmits and receives a wireless signal; and a processor that is connected to the RF unit, wherein the processor is configured to transmit a device to device synchronization signal so as to perform device to device communication with the other terminal.

The processor may determine a transmission policy on the device to device synchronization signal to transmit the device to device synchronization signal using any one of a periodic transmission scheme, an aperiodic transmission scheme, a continuous transmission scheme, a transmission stopping scheme so as to perform the device to device communication with the other terminal.

The periodic transmission scheme may transmit the device to device synchronization signal at a ratio equal to or more than a reference transmission ratio as any one value which is equal to or more than ¼ than time for which the device to device synchronization signal is not transmitted. The aperiodic transmission scheme may set the time for which the device to device synchronization signal is not transmitted to be any one value which is equal to or less than 10 seconds and transmit a device to device transmission signal for the rest time. The continuous transmission scheme may continuously transmit the device to device synchronization signal without stopping the device to device synchronization signal at the time of requesting an emergency call. The transmission stopping scheme may stop the transmission of the device to device synchronization signal when there is no response of the other terminal for at least any one value which is equal to or less than 60 seconds.

The processor may be configured to transmit the device to device synchronization signal with the other terminal so as to make a terminal within a coverage of a base station perform the device to device communication with the other terminal which is out of the coverage of the base station.

The processor may be configured to transmit a first synchronization signal in a frame corresponding to an offset from a first frame which is used for communication with the other terminal. The processor may be configured to further transmit a second synchronization signal after transmitting the first synchronization signal to the other terminal.

The processor may transmit the second synchronization signal using at least one of a scheme of transmitting the second synchronization signal in a frame corresponding to the offset designated from the frame, a scheme of transmitting the second synchronization signal just after the first synchronization signal, a scheme of transmitting the second synchronization signal in a frame which the second synchronization signal does not overlap the first synchronization signal, a scheme of transmitting the second synchronization signal at a final offset of the frame in which the first synchronization signal is positioned, a scheme of transmitting the second synchronization signal within a maximum offset of the frame in which the first synchronization signal is positioned, a scheme of transmitting the second synchronization signal after a minimum offset of the frame in which the first synchronization signal is positioned, a scheme of transmitting the synchronization signal one more after a frame subsequent to the frame in which the first synchronization signal is positioned, a scheme of transmitting the second synchronization signal after a frame transmitting the second synchronization signal notifies the other terminal in advance, a scheme of immediately transmitting the second synchronization signal when a communication problem with the other terminal occurs, a scheme of recording frame information transmitting the second synchronization signal in the frame in which the first synchronization signal is positioned and then transmitting the recorded frame information, and a scheme of recording a frame position of the first synchronization signal and a frame position of the second synchronization signal in the frame and then transmitting the recorded frame positions.

The processor may be configured not to transmit a second synchronization signal when the other terminal reports normal reception of the first synchronization signal to the apparatus. The processor may be configured to use any one of 0 to 39 and 0 to 15 as a transmission frame number of the first synchronization signal and the second synchronization signal.

The processor may be configured to receive a synchronization signal of a base station so as to transmit a device to device synchronization signal for device to device communication to the other terminal.

The processor may be configured to transmit the device to device synchronization signal to the other terminal while synchronizing with the synchronization signal of the base station and transmit synchronization signal information between synchronization terminals of the base station indicating the transmission of the device to device synchronization signal to the other terminal while synchronizing with the synchronization signal of the base station. The synchronization signal information between the synchronization terminals of the base station may be transmitted through at least any one of a device to device communication channel and the device to device synchronization signal.

The processor may be configured to transmit the device to device synchronization signal to the other terminal in asynchronization without synchronizing with the synchronization signal of the base station and transmit synchronization signal information between asynchronization terminals of the base station indicating the transmission of the device to device synchronization signal to the other terminal without synchronizing with the synchronization signal of the base station. The synchronization signal information between the asynchronization terminals of the base station may be transmitted through at least any one of a device to device communication channel and the device to device synchronization signal.

In accordance with one aspect of the present invention, an apparatus for device to device synchronization signal transmission on LTE device to device communication includes: an RF unit that transmits and receives a wireless signal; and a processor that is connected to the RF unit, wherein the processor is configured to set a reference ratio for a frame share ratio of a downlink data transmitted to the other terminal and an uplink data received from the other terminal and perform the device to device communication depending on the reference ratio.

The processor may be configured to divide a frame in a time division scheme and the frame may be composed of 10 sub-frames to divide between the downlink data and the uplink data.

The processor may be configured to repeatedly use at least any one reference ratio of 2:3, 3:2, 4:1, 1:4, 7:3, 3:7, 8:2, 2:8, 9:1, 1:9, 3:3:2:2, 5:5, 3:3:2:2, 2:2:3:3, 1:1:1:1:1:1:1:1:1:1, 2:2:2:2:1:1, 2:2:1:1:2:2, 1:1:2:2:2:2, 4:6, 6:4, 2:3:2:3, 3:2:3:2, 0:10, 10:0, 0:5, and 5:0 as a transmission ratio of the downlink data and the uplink data.

The processor may be configured to designate a frequency division scheme, not a time division scheme, using one of codes used in the reference ratio and make the apparatus using the time division scheme use a reference ratio of 10:0 or 5:0 at the time of using the frequency division scheme.

According to the exemplary embodiments of the present invention, the apparatus for device to device synchronization signal transmission on LTE device to device communication may effectively transmit the synchronization signal which is used the device to device communication.

Further, according to the exemplary embodiments of the present invention, the apparatus for device to device synchronization signal transmission on LTE device to device communication may periodically or aperiodically transmit the synchronization signal to detect the interference with the other terminal, thereby effectively using the wireless channel.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating the configuration of an LTE network according to an exemplary embodiment of the present invention;

FIG. 2 is a diagram illustrating the configuration of dual connectivity when a first base station of FIG. 1 operates as a main base station and a second base station operates independently as a sub-base station;

FIG. 3 is a diagram illustrating the configuration of dual connectivity when the first base station of FIG. 1 operates as a main base station, the second base station operates as a sub-base station, and data is separated and combined through the main base station;

FIG. 4 is a diagram illustrating a configuration in detail when the sub-base station of FIGS. 2 and 3 is disconnected from a terminal;

FIG. 5 is a diagram illustrating a configuration in detail when transmission power for a terminal is allocated to the main base station or the sub-base station of FIGS. 2 and 3;

FIG. 6 is a diagram illustrating a configuration in detail when a terminal randomly accesses the main base station or the sub-base station of FIGS. 2 and 3;

FIG. 7 is a diagram illustrating a configuration of a communication system for device to device synchronization signal transmission on LTE device to device communication according to an exemplary embodiment of the present invention;

FIG. 8 is a diagram illustrating a frame structure in which the terminal of FIG. 7 transmits the synchronization signal;

FIG. 9 is a diagram illustrating another embodiment of the frame structure in which the terminal of FIG. 7 transmits the synchronization signal;

FIG. 10 is a diagram illustrating a structure in which the terminal in the communication system according to the exemplary embodiment of the present invention receives a synchronization signal of a base station and transmits the received synchronization signal to the other terminal;

FIG. 11 is a diagram illustrating a frame structure in which the terminal of FIG. 7 transmits the synchronization signal to the other terminal; and

FIG. 12 is a block diagram illustrating a wireless communication system in which the exemplary embodiment of the present invention may be implemented.

### DESCRIPTION OF SPECIFIC EMBODIMENTS

Detailed exemplary embodiments of the present invention will be described with reference to the accompanying drawings.

The present invention may be modified in various ways and implemented by various exemplary embodiments, so that specific exemplary embodiments are illustrated in the drawings and will be described in detail below. However, it is to be understood that the present invention is not limited to the specific exemplary embodiments, but includes all modifications, equivalents, and substitutions included in the spirit and the scope of the present invention.

Hereinafter, an apparatus for device to device synchronization signal transmission on LTE device to device communication according to an exemplary embodiment of the present invention will be described with reference to the accompanying drawings.

The device to device communication means communications which do not pass through a base station. For this purpose, a device to device synchronization method for device to device time and frequency synchronization, a method for discovering a terminal to be communicated after device to device synchronization, a device to device communication method for performing device to device communication after a terminal is discovered, and the like are required.

First, the device to device synchronization method is performed by a device to device synchronization signal (D2DSS) and a physical D2D synchronization channel (PD2DSCH).

The D2DSS is used for device to device time and frequency synchronization by letting a terminal transmit a synchronization signal and letting the other terminal receive the synchronization signal. Meanwhile, the PD2DSCH means a physical channel through which the D2DSS is transmitted.

When the D2DSS does not utilize a cellular network to which a base station belongs, the D2DSS provides a function like the existing synchronization signal transmitted from the base station. That is, a terminal may acquire synchronization for D2D communication and transmit ID related information of a subject providing a common time reference.

When the cellular network is normally operated, D2D terminals may acquire and use the common time reference from their own base station. For example, in the case of the LTE system, when the terminal accesses the base station, the terminal detects a primary synchronization signal (PSS) and a secondary synchronization signal (SSS) which are a synchronization signal transmitted by the base station to acquire time synchronization and cell IDs for a cell to which the terminal belongs. In this case, the acquired time synchronization may be used as the common time reference.

Meanwhile, the method for discovering a terminal needs to transmit discovery information to the surroundings to inform the other terminal of presence of a terminal in the D2D communication. Further, the other terminal may receive the discovery information to acknowledge the presence of the terminal.

When the other terminal recognizing the discovery information intends to transmit data to a terminal, the other terminal may transmit information associated with the terminal of the D2D itself to the terminal and also transmit control information required to receive information together.

The terminal receiving the information associated with the other terminal performs communications by transmitting ACK/NACK and/or close loop control information, etc., to the other terminal based on a received signal.

Next, the device to device communication method performs communications using a physical channel which is composed of a plurality of traffic slots. Further, independent link scheduling and data transmission are performed for each traffic slot, which is divided into functions of link scheduling, transmission rate scheduling, data transmission, and acknowledgment transmission.

In the link scheduling, a single-tone detection signal using an OFDM signal structure is transmitted to each device to device link for each one-way communication to be able to measure a signal interference relationship between device to device links and determine whether data may be transmitted in the corresponding traffic slot, that is, a medium access or a concession is made.

In the transmission rate scheduling, a detailed transmission rate for the links determining the medium access in the corresponding traffic slot is tuned, in the data transmission, transmission terminals of the links determining the medium access transmit data to the corresponding receiving terminal, and in the acknowledgement transmission, an acknowledgement message for the data transmission may be transmitted.

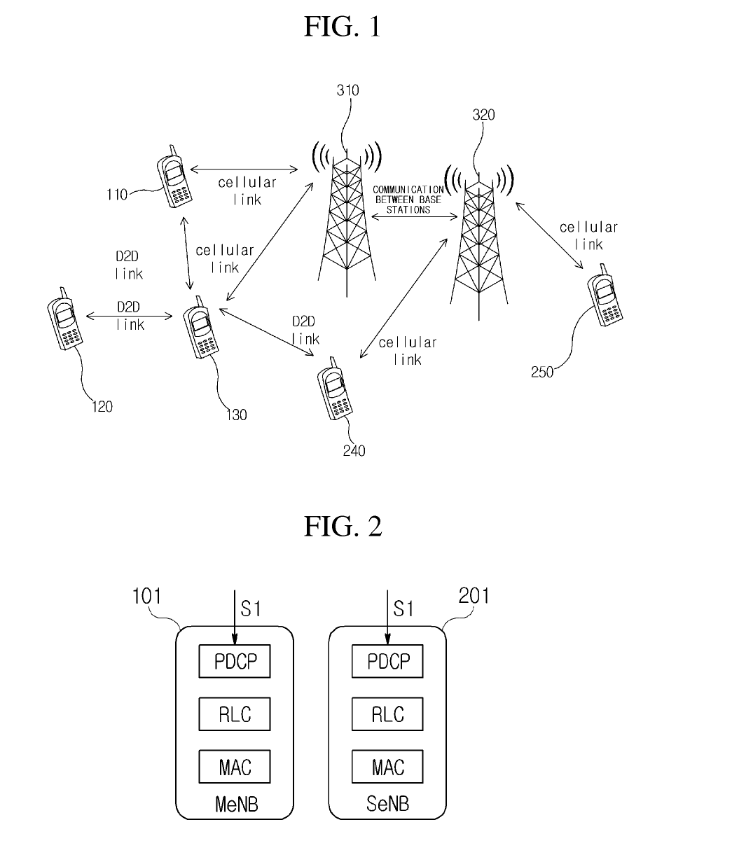

FIG. 1 is a diagram illustrating the configuration of an LTE network according to an exemplary embodiment of the present invention and FIGS. 2 to 6 are configuration diagrams for describing FIG. 1 in detail.

Hereinafter, an apparatus for device to device synchronization signal transmission on LTE device to device communication according to an exemplary embodiment of the present invention will be described with reference to FIGS. 1 to 6.

Referring to FIG. 1 first, an LTE network structure according to an exemplary embodiment of the present invention is composed of base stations and terminals. In particular, new frequencies can be allocated and used for device to device communication, when a macrocell and a D2D channel are separately allocated.

When a macrocell and a D2D channel are both allocated, device to device communication may be achieved by at least any one of adding a sub-channel and using the physical channel used by the macrocell, and at least any one of a channel allocation scheme, a channel management scheme, and a duplexing method may be used for interference between the macrocell and the D2D channel.

Further, synchronization between terminals may be provided from at least any one of an uplink, a downlink, and both of an uplink and a downlink.

In the LTE network structure, in detail, a first terminal 110 and a third terminal 130 are in the cellular link coverage of a first base station 310, and a fourth terminal 240 and a fifth terminal 250 are in the cellular link coverage of a second base station 320.

The third terminal 130 is positioned at a distance where D2D communication with the first terminal 110, the second terminal 120, and the fourth terminal 240 is available The D2D link of the third terminal 130 and the first terminal 110 is in the same first base station 310, the D2D link of the third terminal 130 and the fourth terminal 240 is on another cellular coverage, the D2D link of the third terminal 130 and the second terminal 120 is formed by the second terminal 120 not positioned in any cellular coverage and the third terminal 130 positioned in the cellular coverage of the first base station 310.

The cellular link channel used between the first base station 310 and the third terminal 130 and the D2D link channel used by the third terminal 130 and the fourth terminal 240 may be separately or simultaneously allocated.

For example, when the cellular link channel which is used between the first base station 310 and the third terminal 130 and the D2D link channel which is used by the third terminal 130 and the fourth terminal 240 use the same frequency, OFDM symbols of PDSCH, PDCCH, PUSCH, and PUCCH may be separately allocated.

In particular, the first base station 310 can carry out an allocation schedule of time slots for transmitting a synchronization signal, a discovery signal, and an HARQ for the D2D link channel used by the third terminal 130 and the fourth terminal 240.

The synchronization signal transmitted by the first base station 310 may be used simultaneously with the information about the cellular link of the first base station 310, but the time slots for transmitting a synchronization signal, a discovery signal, and an HARQ for the third terminal 130 and the fourth terminal 240 may be scheduled not to overlap the time slots of the cellular link channels used between the first base station 310 and the third terminal 130.

When the cellular link channel used between the first base station 310 and the third terminal 130 and the D2D link channel used by the third terminal 130 and the fourth terminal 240 use different frequencies, the third terminal 130 and the fourth terminal 240 can exclusively use the OFDM symbols of PDSCH, PDCCH, PUSCH, and PUCCH, and the third terminal 130 or the fourth terminal 240 can perform scheduling.

D2D communication between the third terminal 130 and the fourth terminal 240 is performed, avoiding interference influenced by the first base station 310 and the first terminal 110. In particular, in the D2D communication between the third terminal 130 and the fourth terminal 240, the third terminal 130 uses any one of a way of transmitting a synchronization signal received from the first base station 310 to the fourth terminal 240 through the uplink channel used by the first base station 310, a way of transmitting the synchronization signal to the fourth terminal 240 through the downlink channel used by the first base station 310, and a way of transmitting the synchronization signal to the fourth terminal 240 through both of the uplink and downlink channels used by the first base station 310.

Next, elements required for the D2D data communication will be described with reference to another exemplary embodiment of the present invention.

First, this may be classified into a discovery for discovering a D2D terminal for D2D data communication and D2D communication which is actually communicating later.

The discovery is composed of a signal and a message which are required to discover the D2D terminal, in which the signal and message include discovery information and channel prediction information.

A frame which is used for a message and a sequence of the discovery may be used similar to a physical uplink shared channel (PUSCH) of an LTE uplink, the discovery at a short distance uses a normal cyclic prefix, and the discovery in an extended range uses an extended cyclic prefix.

For transmission of the message and sequence of the discovery, QPSK, a turbo code, an interleaver, and CRC-24 are used.

The message and sequence of the discovery are transmitted at the same frequency and time.

Meanwhile, the D2D communication is used for the D2D communication and includes a use of the physical channel for device to device synchronization and communication.

The synchronization of the D2D communication transmits a D2D synchronization signal to tune the D2D synchronization and uses the same frequency and time between terminals.

The synchronization sequence of the D2D communication includes at least any one of a ZC sequence and an M sequence.

A synchronization content of the D2D communication includes at least any one of an ID of a synchronization source which sends out a synchronization signal, a format of the synchronization source, a resource allocation of a control signal, and data.

The physical channel for the D2D communication includes at least any one of a D2D synchronization signal (D2DSS) which transmits a D2D synchronization signal, a physical D2D synchronization channel which is a physical D2D synchronization channel, a cluster head control channel which is a cluster head control channel, a cluster head data channel which is a cluster head data channel, a D2D data channel, and a request (REQ) channel which requests a resource.

Here, the D2DSS is transmitted from a cluster head which is a synchronization source of a cluster composed of the D2D terminal and provides a synchronization reference.

Further, the PD2DSCH has a cluster head which includes synchronization information and a channel bandwidth which indicate a synchronization state, SFN, and the like and setting information which indicates resource setting information, etc.

Meanwhile, the CH-CCH includes transmission information for transmission which is transmitted from the cluster head to a transmitting terminal and a receiving terminal in the cluster and does not include a control part for decoding.

Further, the CH-DCH also transmits data which are transmitted from the cluster head to the transmitting terminal and the receiving terminal in the cluster and are to be transmitted by the scheduling of the CH-CCH.

The D2D data channel is a channel through which the transmitting terminal in the cluster transmits data to the receiving terminal and monitors CH-CCH information and transmits the monitored CH-CCH information based on the allocated resource.

The REQ channel is a channel used when the transmitting terminal requests resource allocation of the cluster head. The REQ channel requests a D2D buffer state, interference information measured by the transmitting terminal, available transmission power, etc., and the REQ channel of the transmitting terminals are separated into a frequency and then is transmitted to the cluster head.

Therefore, the D2DSS, the PD2DSCH, the CH-CCH, and the CH-SCH which are used to transmit data from the cluster to the terminal, the REQ channel which is used to transmit data the terminal to the cluster head, and the D2D data channel which is used between terminals use any one of a physical broadcast channel (PBCH), a primary synchronization signal/secondary synchronization signal (PSS/SSS), a physical downlink control channel (PDCCH), and a physical uplink control channel (PUCCH) of the LTE.

FIG. 2 is a diagram illustrating a configuration of dual connectivity when the first base station 310 of FIG. 1 operates as a main base station 101 and the second base station 320 operates independently as a sub-base station 201.

The main base station 101 (master eNB) and the sub-base station 201 (secondary eNB), which are used for dual connectivity, are individually connected with a core network.

Accordingly, all of protocols are independent from the main base station 101 and the sub-base station 201, and particularly, data to be transmitted to two base stations is not separated and combined at the base stations.

Here, a packet data convergence protocol (PDCP) is one of the wireless traffic protocol stacks of the LTE which performs IP header compression and decompression, transmission of user data, and sequence number maintenance for a radio bearer.

Further, a radio link control (RLC) is a protocol stack which controls a wireless connection between the PDCP and the MAC.

Further, the media access control (MAC) is a protocol stack which supports multiple access of an wireless channel.

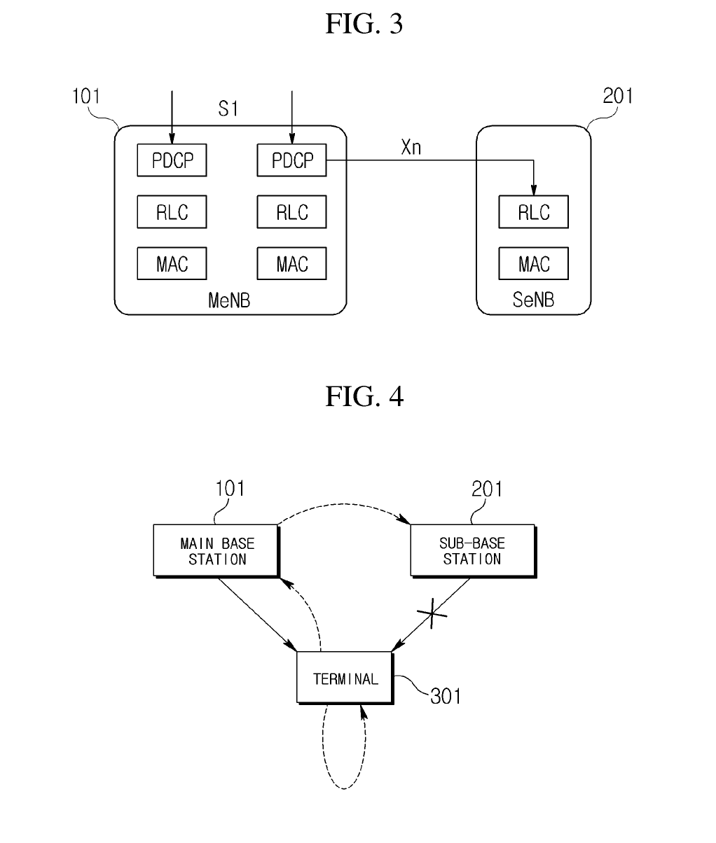

FIG. 3 is a diagram illustrating a configuration of dual connectivity when the first base station 310 of FIG. 1 is operated as the main base station 101, the second base station 320 is operated as the sub-base station 201, and data are separated and combined in the main base station 101.

That is, in connecting the main base station 101 and the sub-base station 201 which are used for the dual connectivity to a core network, only the main base station 101 is connected to the core network and the sub-base station 210 is connected to the core network through the main base station 101.

Therefore, the data which are communicating in the core network are separated and combined at the main base station 101. That is, the data which are separated at the main base station 101 are transmitted to the sub-base station 201 or the data received by the sub-base station 201 are combined and transmitted to the core network.

FIG. 4 is a diagram illustrating a configuration in detail when the sub-base station 201 of FIGS. 2 and 3 is disconnected from a terminal 301.

That is, the apparatus for device to device synchronization signal transmission on LTE device to device communication includes the main base station 101 which allocates radio resources to the terminal 301 to perform data communication with the terminal 301, the sub-base station 201 which performs data communication with the terminal 301, simultaneously with the main base station 101, and the terminal 301 which performs data communication with both of the main base station 101 and the sub-base station 201 and when the link with the sub-base station 201 is disconnected, again sets a radio resource control.

Here, when the terminal 301 is normally connected to the sub-base station 201, the terminal 301 informs the main base station 101 of connection state information and the main base station 101 also informs the sub-base station 201 of link state information between the sub-base station 201 and the terminal 301.

Similarly, when the terminal 301 is abnormally connected with the main base station 101, the terminal 301 resets a radio resource control and reports it to the sub-base station 201 and the sub-base station 201 reports the abnormal connection to the main base station 101.

The communication between the main base station 101 and the sub-base station 201 may be performed by adding information to a frame in an X2 interface or by a broadband network, and when they are not connected by a wire, wireless backhaul may be used for the communication. A signal system including a link state header showing the link state of the main base station 101 and the sub-base station 201, a link state, a base station ID, and a terminal ID may be used for the information in the frame.

Accordingly, when there is a problem with connection in any one of the main base station 101 and the sub-base station 201, the terminal 301 reports it to any one of the main base station 101 and the sub-base station 201, which has no problem, and the base station receiving the report informs the base station with the problem with connection of the report so that the state of connection with the terminal 301 can be checked.

On the other hand, when there is a problem with connection in both of the main base station 101 and the sub-base station 201, similarly, the terminal 301 resets the a radio resource control to allow for communication with the base stations.

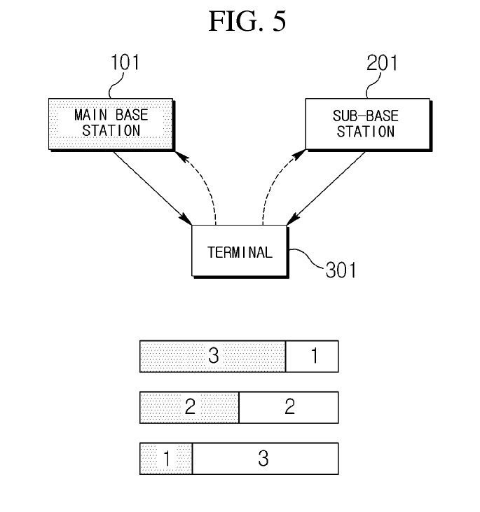

FIG. 5 is a diagram illustrating a configuration in detail when transmission power for the terminal 301 is allocated to the main base station 101 or the sub-base station 201 of FIGS. 2 and 3.

That is, the apparatus for device to device synchronization signal transmission on LTE device to device communication includes the main base station 101 which allocates radio resources to the terminal 301 to perform data communication with the terminal 301, the sub-base station 201 which performs data communication with the terminal 301, simultaneously with the main base station 101, and the terminal 301 which sets an upper limit ratio of transmission power of the main base station 101 and the sub-base station 201 based on a statistic analysis of power sent out to the main base station 101 and the sub-base station 201.

The statistic analysis is analyzing a transmission power ratio on the basis of the average power sent out from the terminal 301 to the main base station 101 and the sub-base station 201, and the terminal 301 reports the upper limit ratio of transmission power to the main base station 101 and the sub-base station 201.

That is, the terminal 301 sets the power ratio to send out to the main base station 101 and the sub-base station 201 on the basis of the average value of the maximum power, which can be sent out by the terminal 301, and the transmission values sent out to the main base station 101 and the sub-base station 201.

For example, it sets the ratio of power to send out to the main base station 101 and the sub-base station 201 as 3:1, 2:2, and 1:3.

As another example, when power to be transmitted is distributed, first, it is very important to maintain connectivity with the main base station 101 or transmit a control signal, so, in order to transmit the signal, power may be allocated to the main base station 101 first and then the remaining power may be distributed for data transmission/reception with the sub-base station 201.

As another example, the power available for transmitting data to the sub-base station 201 may be dynamically changed. That is, an MCS (Modulation and Coding Scheme) value may depend on the available power, even if the wireless channel does not change.

A data transmission error may be generated, when the power distribution and the MCS value are simultaneously changed, so that a change of the power distribution and a change of the MCS value may not be simultaneously performed.

Alternatively, when the power distribution and the MCS value are simultaneously changed, a period of reporting a CQI (Channel Quality Indicator) for changing the MCS, which is a feedback signal system, may be set not to be generated simultaneously with the change of the power distribution, in order to prevent a data transmission error.

On the other hand, at least any one of the maximum value of a terminal, the ratio of power that is being used, the maximum transmission power for each base station according to a power ratio, and the margin of the maximum power, which can be transmitted to the base stations, to the power currently sent out to the terminal can be reported to the main base station 101 and the sub-base station 201.

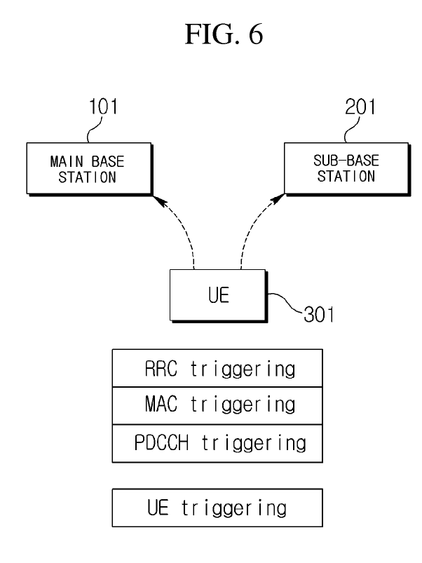

FIG. 6 is a diagram illustrating a configuration in detail when the terminal 301 randomly accesses the main base station 101 or the sub-base station 201 of FIGS. 2 and 3.

That is, the apparatus for device to device synchronization signal transmission on LTE device to device communication includes the main base station 101 which allocates radio resources to the terminal 301 to perform data communication with the terminal 301, the sub-base station 201 which performs data communication with the terminal 301, simultaneously with the main base station 101, and the terminal 301 which sends out any one of a random access by triggering to the main base station 101 and the sub-base station 201 and a random access without triggering to at least any one of the main base station 101 and the sub-base station 201.

The triggering is performed by any one triggering command of PDCCH, MAC, and RRC and the sub-base station 201 includes a base station, which can be accessed first, of base stations that can operate as the sub-base station 201.

The random access is transmitted in any one type of a preamble without contents, initial access, a radio resource control message, and a terminal ID.

That is, the random access, which is used for initial access to the main base station 101 or the sub-base station 201, establishment and re-establishment of radio resource control, and handover, may be sent out to any one of the main base station 101 and the sub-base station 201 or simultaneously to the main base station 101 or the sub-base station 201.

Random access may be sent out by PDCCH, MAC, and RRC (Radio Resource Control) triggering from the main base station 101 or the sub-base station 201, but it may be sent out by triggering of a terminal itself.

Further, random access may be sent out by using the remaining power except for the power distributed to an uplink.

On the other hand, when the main base station 101 or the sub-base station 201 is newly turned on, an error may be generated in data communication due to simultaneous random access of surrounding terminals, including the terminal 301.

Accordingly, in order to reduce such influence, the terminal 301 may perform random access, additionally using a random time around ten seconds, when the main base station 101 or the sub-base station 201 is newly turned on. The ‘ten seconds’ is the maximum random access time that is variable in accordance with the number of terminals and the number of base stations and the maximum random access time may be any one in the range of one second to sixty seconds, depending on the environment.

Meanwhile, since the terminal 301 can use a multi-antenna, it is possible to minimize interference influence by finding the transmission position of the main base station 101 or the sub-base station 201 and performing random access toward the main base station 101 or the sub-base station 201.

Alternatively, when the exact positions of the main base station 101 and the sub-base station 201 are not found, the terminal 301 may perform random access by sweeping at 360 degrees.

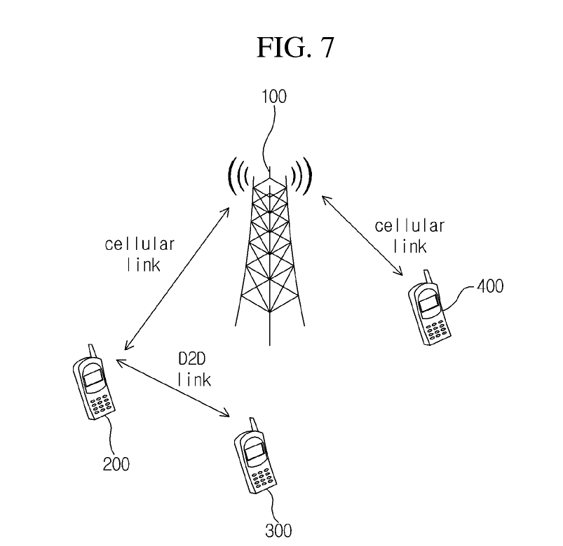

FIG. 7 is a diagram illustrating a configuration of a communication system for device to device synchronization signal transmission on LTE device to device communication according to an exemplary embodiment of the present invention. The system may include the base station 100, the terminal 200, the other terminal 300, and an interference terminal 400. In this configuration, the terminal 200 may determine a transmission policy on the device to device synchronization signal to transmit the device to device synchronization signal using any one of a periodic transmission scheme, an aperiodic transmission scheme, a continuous transmission scheme, and a transmission stopping scheme, thereby performing the device to device communication with the other terminal 300.

In this case, the terminal 200 may use at least any one of the periodic transmission type which transmits the device to device synchronization signal at a ratio equal to or more than a reference transmission ratio as any one value which is equal to or more than ¼ than time for which the device to device synchronization signal is not transmitted, the aperiodic transmission scheme which sets the time for which the device to device synchronization signal is not transmitted to be any one value which is equal to or less than 10 seconds as a reference and transmits a device to device transmission signal for the rest time, the continuous transmission scheme which continuously transmits the device to device synchronization signal without stopping the device to device synchronization signal at the time of requesting an emergency call, and the transmission stopping scheme which stops the transmission of the device to device synchronization signal when there is no response of the other terminal 300 for at least any one value which is equal to or less than 60 seconds.

That is, the terminal 200 transmits the device to device synchronization signal to the other terminal 300 to provide the synchronization signal, but puts the time for which the device to device synchronization signal is not transmitted, and as a result, the exemplary embodiment of the present invention may discover the interference terminal 400 which is far away from the other terminal 300. Further, the exemplary embodiment of the present invention analyzes the interference of the interference terminal 400 which affects the other terminal 300 and avoids the interference, thereby reducing the interference and effectively using the wireless channel.

Therefore, the transmission of the device to device synchronization signal may be divided into the periodic, aperiodic, continuous, and stopping schemes.

At the time of periodically transmitting the device to device synchronization signal, the transmission time may use, as a reference, at least one value which is equal to or more than ¼ as short as the time for which the device to device synchronization signal is not transmitted. If the time for which the device to device synchronization signal is not transmitted is four times as long as the time for which the device to device synchronization is transmitted, the interference may be sufficiently measured.

That is, if it is assumed that the device to device synchronization signal is transmitted every 0.5 ms, it takes 16 ms when the device to device synchronization signal is transmitted 32 times and an idle time may use a specific value among values which are equal to or less than 64 ms which are four times as long as 16 ms.

For example, if it is assumed that the time for which the device to device synchronization signal is not transmitted is equal to or less than four times as long as the time for which the device to device synchronization signal is transmitted, 40 ms which is shorter than 64 ms may also be used when the device to device synchronization signal is transmitted 32 times.

Meanwhile, when the device to device synchronization signal is aperiodically transmitted, the idle time of the device to device synchronization signal may use any reference value of about 10 seconds. For example, when the terminal 200 or the other terminal 300 move, the time for which the wireless channel is stabilized is required, and therefore the terminal 200 may retransmit the device to device synchronization signal after any one value which is equal to or less than a maximum of 10 seconds which is the time for which the wireless channel is stabilized.

For example, when a moving speed of the terminal 200 or the other terminal 300 is fast, the device to device synchronization signal may be also retransmitted at 1 second or less.

However, when there is no response of the other terminal 300, the transmission stops at any one value which is equal to or less than 60 seconds as a reference and thus the wireless channel is not shared.

Meanwhile, when the terminal 200 requests an emergency call like disaster communication with the other terminal 300, the terminal 200 may continuously transmit the device to device synchronization signal without the idle time.

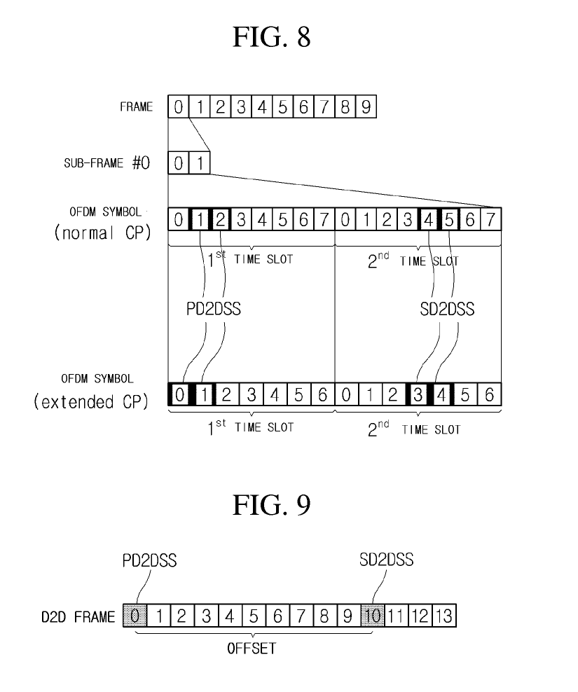

FIG. 8 is a diagram illustrating a frame structure in which the terminal 200 of FIG. 7 transmits the synchronization signal.

Here, the apparatus for device to device synchronization signal transmission on LTE device to device communication includes the terminal 200 which sends out the device to device synchronization signal and the discovery signal to the other terminal 300 and receives a response thereto from the other terminal 300 to perform the device to device communication.

The terminal 200 may use, as a parameter, at least any one of using specific value or less among codes ½ or less as a turbo code and using the ½ as an initial value, using about 80 MHz as a bandwidth and using 20 MHz as an initial value, using any one of FDD and TDD as a duplex mode and using the TDD as an initial value, using any modulation scheme of 64 QAM or less as a modulation scheme and using the 64 QAM as an initial value, and using normal and extended as a cyclic prefix (CP) and using the normal as an initial value.

Further, the device to device synchronization signal may include a primary D2D synchronization signal (PD2DSS) and a secondary D2D synchronization signal (SD2DSS). When the extended CP symbol is used, the PD2DSS may be positioned at Nos. 0 and 1 of a first slot of a sub-frame and the SD2DSS may be positioned at Nos. 3 and 4 of a second slot of the sub-frame.

That is, when the terminal 200 performs the device to device communication with the other terminal 300, a distance between the other terminal 300 and the terminal 200 may be close to each other and far away from each other. Therefore, the turbo code, the bandwidth, the duplex, the modulation scheme, and the cyclic prefix may be set to be appropriately used depending on the cases.

First, the turbo code which recovers errors occurring depending on a quality of the wireless channel uses a specific value or less among the codes of ½ or less which is a maximum value of the turbo code to prepare for the case in which the device to device channel state is poor and uses the ½ as the initial value.

Further, the available frequency bandwidth uses 20 MHz or more which is a minimum bandwidth and 80 MHz or less which is a maximum bandwidth and uses 20 MHz which is the smallest bandwidth as an initial value in consideration of the interference problem.

As the division scheme of transmission and reception, both of the frequency division duplex (FDD) which divides transmission and reception based on frequency and the time division duplex (TDD) which divides transmission and reception based on time may be used. In this case, when the FDD is used for the device to device communication, a transmitting and receiving frequency which communicates with the base station 100 may be changed, and therefore the terminal 200 or the other terminal 300 may include transmitting and receiving hardware for two frequencies.

On the other hand, when the TDD is used, only the transmitting and receiving hardware for one frequency may be provided. Therefore, when the terminal 200 communicates with the terminal 300, the duplex mode uses both of the FDD/TDD and the transmitting and receiving hardware may use a simple TDD as the initial value.

The modulation scheme uses a maximum of 64 QAM under the assumption that wireless channel environment is good and may use the 64 QAM, which may perform transmission three times faster than QPSK, as the initial value.

Meanwhile, the cyclic prefix which is a guard time for which a signal fading depending on the radio environment may be recovered may use the normal and the extended in consideration of the device to device distance and may use the normal as the initial value under the assumption that the terminal 200 is close to the other terminal 300.

Meanwhile, the D2D Synchronization signal (D2DSS) which is the device to device synchronization signal may transmit the primary D2DSS (PD2DSS) and the secondary D2DSS (SD2DSS) for accurate synchronization acquisition.

In this case, in the case of the time of the normal CP and in the case of using the extended CP, the number of OFDM symbols which is transmitted at a time slot in the sub-frame in which the PD2DSS and the SD2DSS may be transmitted is differently defined based on a length of the CP. That is, when the normal CP is used, 14 (Nos. 0 to 13) OFDM symbols per one time slot may be used and in the case of using the extended CP, 12 (Nos. 0 to 11) OFDM symbols per one time slot may be used.

For maintaining the accurate synchronization, the PD2DSS and the SD2DSS each may continuously use two OFDM symbols. In this case, when the normal CP is used, two time slots which are composed of 14 OFDM symbols per a time slot may be used and the PD2DSS may be positioned at Nos. 1 and 2 of the first time slot and the SD2DSS may be continuously positioned at Nos. 4 and 5.

However, when the extended CP is used, it is composed of 12 OFDM symbols per a time slot, and therefore the position of the PD2DSS and the SD2DSS may also be changed.

For example, if the OFDM symbol is not changed, the PD2DSS may be positioned at Nos. 1 and 2 of the first time slot and the SD2DSS may be continuously positioned at Nos. 4 and 5 of the second time slot, when the OFDM symbol is sent earlier than one, the PD2DSS may be positioned at Nos. 0 and 1 of the first time slot and the SD2DSS may be continuously positioned at Nos. 3 and 4 of the second time slot, or when the OFDM symbol is sent with being delayed by one, the PD2DSS may be positioned at Nos. 2 and 3 of the first time slot and the SD2DSS of the second time slot may be continuously positioned at Nos. 5 and 6.

The exemplary embodiment of the present invention may maintain the accurate synchronization and easily demodulate the synchronization signal by the disposition of the device to device synchronization signal.

The synchronization signals may be disposed to enable the terminal to easily perform the demodulation and when the synchronization signals approach each other, the synchronization may be certainly made but the synchronization may not be made over time.

Meanwhile, even though the synchronization quality slightly deteriorates when the synchronization signals are separated from each other, the synchronization quality may be excellent over time.

FIG. 9 is a diagram illustrating another embodiment of the frame structure in which the terminal 200 of FIG. 7 transmits the synchronization signal.

Here, the apparatus for device to device synchronization signal transmission on LTE device to device communication includes the terminal 200 which transmits the synchronization signal to the other terminal 300 to make the terminal within the coverage of the base station 100 perform the device to device communication with other terminal 300 which is out of the coverage of the base station 100.

Here, the terminal 200 may transmit a first synchronization signal (for example, PD2DSS) in a frame corresponding to an offset from the first frame which is used for communication with the other terminal 300.

Further, the terminal 200 may transmit a second synchronization signal (for example, SD2DSS) after transmitting the first synchronization signal to the other terminal 300.

For example, the terminal 200 may transmit the second synchronization signal using at least one of a scheme of transmitting the second synchronization signal in a frame corresponding to the offset designated from the frame, a scheme of transmitting the second synchronization signal just after the first synchronization signal, a scheme of transmitting the second synchronization signal in a frame which the second synchronization signal does not overlap the first synchronization signal, a scheme of transmitting the synchronization signal at a final offset of the frame in which the first synchronization signal is positioned, a scheme of transmitting the synchronization signal within a maximum offset of the frame in which the first synchronization signal is positioned, a scheme of transmitting the synchronization signal after a minimum offset of the frame in which the first synchronization signal is positioned, a scheme of transmitting the synchronization signal one more after a frame subsequent to the frame in which the first synchronization signal is positioned, a scheme of transmitting the second synchronization signal after a frame transmitting the second synchronization signal notifies the other terminal 300 in advance, a scheme of immediately transmitting the second synchronization signal when a communication failure with the other terminal 300, a scheme of recording frame information transmitting the second synchronization signal in the frame in which the first synchronization signal is positioned and then transmitting the recorded frame information, and a scheme of recording a frame position of the first synchronization signal and a frame position of the second synchronization signal in the frame and then transmitting the recorded frame positions.

Here, when the other terminal 300 reports the normal reception of the first synchronization signal to the terminal 200, the terminal 200 does not transmit the second synchronization signal.

Further, the terminal 200 may use any one of Nos. 0 to 39 and 0 to 15 as the transmission frame number of the first synchronization signal and the second synchronization signal.

For example, to make the terminal 200 within the coverage of the base station 100 perform the device to device communication with other terminal 300 which is out of the coverage of the base station 100, at least two synchronization signals may be sent, in which the first synchronization signal may be sent in the first frame and any one of arbitrarily defined frames.

An additionally transmitted synchronization signal may be transmitted in a frame subsequent to the first synchronization signal, transmitted at the defined time, or a final frame.

The synchronization signals may be disposed to enable the terminal to easily perform the demodulation and when the synchronization signals approach each other, the synchronization may be certainly made but the synchronization may not be made over time.

Meanwhile, even though the synchronization quality slightly deteriorates when the synchronization signals are separated from each other, the synchronization quality may be excellent over time.

Therefore, at least two synchronization signals may be sent depending on the wireless quality, and the information on the position of the first synchronization signal may be sent in the first frame in some cases and the information on the synchronization signal transmission frame may also be sent in the first frame or may be sent by representing the position information in a frame including the first synchronization signal.

Here, the number of frame offsets to be transmitted may be 40 composed of 0 to 39 but when 4 bits are used depending on the implementation scheme of the terminal 200, only 16 frame offsets may be available.

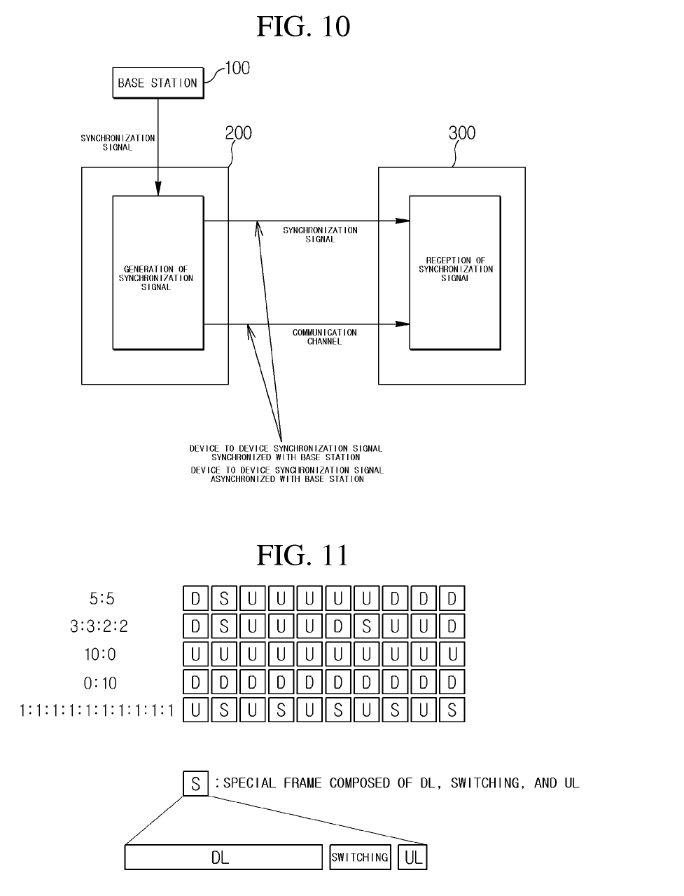

FIG. 10 is a diagram illustrating a structure in which the terminal in the communication system according to the exemplary embodiment of the present invention receives a synchronization signal of a base station and transmits the received synchronization signal to the other terminal.

The communication system includes the terminal 200 which receives the synchronization signal of the base station 100 to transmit the device to device synchronization signal for device to device communication to the other terminal 300.

In this case, the terminal 200 may transmit the device to device synchronization signal to the terminal 300, with synchronizing with the synchronization signal of the base station 100.

Further, the terminal 200 may transmit the synchronization signal information between the synchronization terminals of the base station transmitting the device to device synchronization signal to the other terminal 300, with synchronizing with the synchronization signal of the base station 100.

Further, the terminal 200 may transmit and receive the synchronization signal information between the synchronization terminals of the base station through the device to device communication channel and at least one of the device to device synchronization signals.

Further, the terminal 200 may transmit the device to device synchronization signal to the terminal 300 in asynchronization without synchronizing with the synchronization signal of the base station 100.

Further, the terminal 200 may transmit the synchronization signal information between the asynchronization terminals of the base station transmitting the device to device synchronization signal to the other terminal 300 without synchronizing with the synchronization signal of the base station 100.

Further, the terminal 200 may transmit and receive the synchronization signal information between the asynchronization terminals of the base station through the device to device communication channel and at least one of the device to device synchronization signals.

That is, for the device to device communication, the terminal 200 may transmit the synchronization signal information between the synchronization terminals of the base station which is information on whether the terminal 200 is synchronized with the base station 100 to the other terminal 300.

In this case, the terminal 200 may transmit the synchronization signal information between the synchronization terminals of the base station to the other terminal 300 through the device to device communication channel which is used as the device to device communication channel and at least any one of the device to device synchronization signals.

Meanwhile, when the terminal 200 wants to access the other terminal 300 in asynchronization even though the terminal 200 is synchronized with the base station 100, the terminal transmits the synchronization signal information between the asynchronization terminals of the base station to the other terminal 300.

In this case, the terminal 200 may transmit the synchronization signal information between the asynchronization terminals of the base station to the other terminal 300 through the device to device communication channel which is used as the device to device communication channel and at least any one of the device to device synchronization signals.

In this case, the synchronization signal information between the synchronization terminals of the base station may be used to make the terminal 200 send out the same signal as the base station 100 to the other terminal 300, with synchronizing with the base station 100. The synchronization signal information between the asynchronization terminals of the base station may be used to synchronize the other terminal 300 which is out of the coverage of the base station with the terminal 200. In this case, to synchronize the terminal 200 with the other terminal 300, the terminal 200 may communicate with the other terminal 300 using the information which does not synchronize with the base station 100.

However, the synchronization signal information needs to include a power control for avoiding the interference with the base station 100 and may be used at a cell boundary area at which the received intensity of the base station 100 is weak.

Meanwhile, the synchronization signal information between the terminals of the base station may be represented by 1 bit and uses the physical D2D shared channel (PD2DSCH) to be used for the D2D communication. In this case, the synchronization signal information between the terminals of the base station may also be divided into the synchronization signal information of the synchronization terminals of the base station and the synchronization signal information between the asynchronization terminals of the base station.

For example, when the terminal 200 is in in-coverage, the synchronization signal information between the terminals of the base station may be transmitted to the other terminal, while being set to be 1. Further, when the other terminal 300 receives the device to device synchronization signal from the terminal 200 which is in the in-coverage and then re-transmits the device to device synchronization signal to other terminals, the other terminal 300 does not directly receive the device to device synchronization signal from the base station and therefore may transmit the synchronization signal information between the terminals of the base station to other terminals, while being set to be 0.

Next, the device to device synchronization signal sets the synchronization signal information between the terminals of the base station to be 0 to inform other terminals that it is the synchronization signal information between the asynchronization terminals of the base station.

By this configuration, the exemplary embodiment of the present invention may notify other terminals of whether the terminal synchronizes with the base station by a simple and efficiency manner, in communication the device to device synchronization signal between the terminals.

FIG. 11 is a diagram illustrating an exemplified frame structure in which the terminal 200 of FIG. 7 transmits the synchronization signal to the other terminal 300.

Here, the apparatus for device to device synchronization signal transmission on LTE device to device communication includes the terminal 200 which sets a reference ratio for a frame shared ratio of a downlink data transmitted to the other terminal 300 and an uplink data received from the other terminal 300 and performs the device to device communication depending on the reference ratio.

Here, the terminal 200 divides a frame in a time division scheme, in which the frame is composed of 10 sub-frames to be able to divide between the downlink data and the uplink data.

Further, the terminal 200 may repeatedly use at least any one reference ratio of 2:3, 3:2, 4:1, 1:4, 7:3, 3:7, 8:2, 2:8, 9:1, 1:9, 3:3:2:2, 5:5, 3:3:2:2, 2:2:3:3, 1:1:1:1:1:1:1:1:1:1, 2:2:2:2:1:1, 2:2:1:1:2:2, 1:1:2:2:2:2, 4:6, 6:4, 2:3:2:3, 3:2:3:2, 0:10, 10:0, 0:5, and 5:0 as a transmission ratio of the downlink data and the uplink data.

Here, the terminal 200 may designate the frequency division scheme, not the time division scheme, using one of codes used in the reference ratio and make the terminal 200 using the time division scheme use the reference ratio of 10:0 or 5:0 at the time of using the frequency division scheme.

That is, the transmission ratio of the downlink data and the uplink data in the device to device communication may be determined by using the existing method used between the base station 100 and the terminal 200, fairly distributing a two-way data between the terminal 200 and the other terminal 300, or balancing between the uplink data and the downlink data.

Here, the existing method uses 2:3, 3:2, 4:1, 7:3, 8:2, 9:1, and 3:3:2:2 which are used in the existing long term evolution (LTE) to repeatedly transmit the downlink data and the uplink data without being changed.

Further, fairly distributing the two-way data between the terminals uses at least any one of 5:5, 3:3:2:2, 2:2:3:3, 1:1:1:1:1:1:1:1:1:1, 2:2:2:2:1:1, 2:2:1:1:2:2, and 1:1:2:2:2:2 to repeatedly transmit the downlink data and the uplink data without being changed.

Further, since the downlink data are not necessarily many between the terminal 200 and the other terminal 300 but the upward data may be more, the transmission ratio of the downlink data and the uplink data may be changed.

That is, balancing between the uplink data and the downlink data uses at least one of 3:2, 2:3, 1:4, 3:7, 2:8, 1:9, and 3:3:2:2 which represent the change of the downlink data and the uplink data of the existing LTE to repeatedly transmit the downlink data and the uplink data without being changed.

Meanwhile, when the uplink data or the downlink data are many, as the transmission ratio, 0:10 and 0:5 or 10:0 and 5:0 may also be used and in the case of 0:10 and 0:5, the downlink data may not be received and thus the problem of the synchronization or the power control may occur, and therefore, in the case of 0:10 and 0:5, the number of frames which is transmitted at 0:10 and 0:5 may be sent out in advance.

The terminal 200 may control the transmission ratio per 5 sub-frames or 10 sub-frames and use the controlled transmission ratio.

No. 000 among the codes which are used in a reference ratio composed of 3 bits may mean the frequency division scheme and when the terminal 200 uses the time division scheme, the reference ratio code No. 000 may recognize and use the reference ratio as 10:0 or 5:0 which transmits only the downlink data.

For example, in the case of including the frequency division scheme, 8 reference ratios may be used, 8:2, 2:8, 6:4, and 4:6 which are in the middle process are deleted, and in the case of including 3:3:2:2 which fast repeats the upward data and the downlink data in 5:5, the reference ratio may also be set to be 0(10:0), 1(9:1), 2(7:3), 3(5:5), 4(3:3:2:2), 5(3:7), 6(1:9), and 7(0:10).

This is only any one example of the reference ratios, and therefore the above-mentioned code may be available as a main reference ratio and a reference ratio which is not described above may be included.

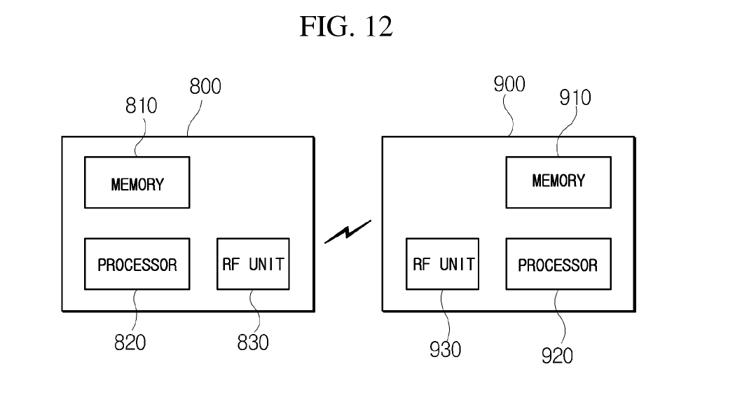

FIG. 12 is a block diagram illustrating a wireless communication system in which the exemplary embodiment of the present invention may be implemented. A wireless communication system illustrated in FIG. 8 may include at least one base station 800 and at least one terminal 900.

The base station 800 may include a memory 810, a processor 820, and an RF unit 830. The memory 810 is connected to the processor 820 to store commands and various kinds of information for executing the processor 820. The RF unit 830 is connected to the processor 820 to be able to transmit and receive external entity and a wireless signal. The processor 820 may perform the operations of the base station in the foregoing exemplary embodiments. In detail, the operations of the base stations 100, 101, 201, and the like in the foregoing exemplary embodiments may be performed by the processor 820.

A terminal 900 may include a memory 910, a processor 920, and an RF unit 930. The memory 910 is connected to the processor 920 to store commands and various kinds of information for executing the processor 920. The RF unit 930 is connected to the processor 920 to be able to transmit and receive external entity and a wireless signal. The processor 920 may execute the operations of the terminal in the foregoing exemplary embodiments. In detail, the operations of the terminals 200, 300, 301, 400, and the like in the foregoing exemplary embodiments may be performed by the processor 920.

The present invention may be modified in various ways and implemented by various exemplary embodiments, so that specific exemplary embodiments are shown in the drawings and will be described in detail.

However, it is to be understood that the present invention is not limited to the specific exemplary embodiments, but includes all modifications, equivalents, and substitutions included in the spirit and the scope of the present invention.

Terms used in the specification, ‘first’, ‘second’, etc., may be used to describe various components, but the components are not to be construed as being limited to the terms. The terms are used to distinguish one component from another component. For example, the ‘first’ component may be named the ‘second’ component, and vice versa, without departing from the scope of the present invention. The term ‘and/or’ includes a combination of a plurality of items or any one of a plurality of terms.

It should be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween.

Terms used in the present specification are used only in order to describe specific exemplary embodiments rather than limiting the present invention. Singular forms are intended to include plural forms unless the context clearly indicates otherwise. It will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification including technical and scientific terms has the same meaning as those that are understood by those skilled in the art. It must be understood that the terms defined by the dictionary are identical with the meanings within the context of the related art, and they should not be ideally or excessively formally defined unless the context clearly dictates otherwise.

Hereinafter, exemplary embodiments of the present invention will be described in more detail with reference to the accompanying drawings. In order to facilitate the general understanding of the present invention in describing the present invention, through the accompanying drawings, the same reference numerals will be used to describe the same components and an overlapped description of the same components will be omitted.

In one or more exemplary embodiments, the described functions may be achieved by hardware, software, firmware, or combinations of them. If achieved by software, the functions can be maintained or transmitted as one or more orders or codes in a computer-readable medium. The computer-readable medium includes all of communication media and computer storage media including predetermined medial facilitating transmission of computer programs from one place to another place.

If achieved by hardware, the functions may be achieved in one or more ASICs, DSPs, DSPDs, PLDs, FPGAs, processors, controllers, microcontrollers, microprocessors, other electronic units designed to perform the functions, or combinations of them.

If achieved by software, the functions may be achieved by software codes. The software codes may be kept in memory units and executed by processors. The memory units may be achieved in processors or outside processors, in which the memory units may be connected to processors to be able to communicate by various means known in the art.

Although the present invention was described above with reference to exemplary embodiments, it should be understood that the present invention may be changed and modified in various ways by those skilled in the art, without departing from the spirit and scope of the present invention described in claims.

What is claimed is:

1. An apparatus for device to device synchronization signal transmission on device to device communication, comprising:
an RF unit that transmits and receives a wireless signal; and
a processor that is connected to the RF unit,
wherein the processor is configured to transmit a device to device synchronization signal so as to perform device to device communication with the other terminal.

2. The apparatus of claim 1, wherein the processor is configured to transmit the device to device synchronization signal using any one of a periodic transmission scheme, an aperiodic transmission scheme, a continuous transmission scheme, a transmission stopping scheme so as to perform the device to device communication with the other terminal.

3. The apparatus of claim 2, wherein the periodic transmission type transmits the device to device synchronization signal at a ratio equal to or more than a reference transmission ratio as any one value which is equal to or more than ¼ than time for which the device to device synchronization signal is not transmitted,
the aperiodic transmission scheme sets the time for which the device to device synchronization signal is not transmitted to be any one value which is equal to or less than 10 seconds and transmits a device to device transmission signal for the rest time,
the continuous transmission scheme continuously transmits the device to device synchronization signal without stopping the device to device synchronization signal at the time of requesting an emergency call, and
the transmission stopping scheme stops the transmission of the device to device synchronization signal when there is no response of the other terminal for at least any one value which is equal to or less than 60 seconds.

4. The apparatus of claim 1, wherein the processor is configured to transmit the device to device synchronization signal with the other terminal so as to make a terminal within a coverage of a base station perform the device to device communication with the other terminal which is out of the coverage of the base station.

5. The apparatus of claim 4, wherein the processor is configured to transmit a first synchronization signal in a frame corresponding to an offset from a first frame which is used for communication with the other terminal.

6. The apparatus of claim 5, wherein the processor is configured to further transmit a second synchronization signal after transmitting the first synchronization signal to the other terminal, and
the processor transmits the second synchronization signal using at least one of a scheme of transmitting the second synchronization signal in a frame corresponding to the offset designated from the frame, a scheme of transmitting the second synchronization signal just after the first synchronization signal, a scheme of transmitting the second synchronization signal in a frame which the second synchronization signal does not overlap the first synchronization signal, a scheme of transmitting the second synchronization signal at a final offset of the frame in which the first synchronization signal is positioned, a scheme of transmitting the second synchronization signal within a maximum offset of the frame in which the first synchronization signal is positioned, a scheme of transmitting the second synchronization signal after a minimum offset of the frame in which the first synchronization signal is positioned, a scheme of transmitting the synchronization signal one more after a frame subsequent to the frame in which the first synchronization signal is positioned, a scheme of transmitting the second synchronization signal after a frame transmitting the second synchronization signal notifies the other terminal in advance, a scheme of immediately transmitting the second synchronization signal when a communication problem with the other terminal occurs, a scheme of recording frame information transmitting the second synchronization signal in the frame in which the first synchronization signal is positioned and then transmitting the recorded frame information, and a scheme of recording a frame position of the first synchronization signal and a frame position of the second synchronization signal in the frame and then transmitting the recorded frame positions.

7. The apparatus of claim 4, wherein the processor is configured not to transmit a second synchronization signal when the other terminal reports normal reception of the first synchronization signal to the apparatus.

8. The apparatus of claim 6, wherein the processor is configured to use any one of 0 to 39 and 0 to 15 as a transmission frame number of the first synchronization signal and the second synchronization signal.

9. The apparatus of claim 1, wherein the processor is configured to receive a synchronization signal of a base station so as to transmit a device to device synchronization signal for device to device communication to the other terminal.

10. The apparatus of claim 9, wherein the processor is configured to transmit the device to device synchronization signal to the other terminal while synchronizing with the synchronization signal of the base station and transmit synchronization signal information between synchronization terminals of the base station indicating the transmission of the device to device synchronization signal to the other terminal while synchronizing with the synchronization signal of the base station, and
the synchronization signal information between the synchronization terminals of the base station is transmitted through at least any one of a device to device communication channel and the device to device synchronization signal.

11. The apparatus of claim 9, wherein the processor is configured to transmit the device to device synchronization signal to the other terminal in asynchronization without synchronizing with the synchronization signal of the base station and transmit synchronization signal information between asynchronization terminals of the base station indicating the transmission of the device to device synchronization signal to the other terminal without synchronizing with the synchronization signal of the base station, and
the synchronization signal information between the asynchronization terminals of the base station is transmitted through at least any one of a device to device communication channel and the device to device synchronization signal.

12. An apparatus for device to device synchronization signal transmission on LTE device to device communication, comprising:
an RF unit that transmits and receives a wireless signal; and
a processor that is connected to the RF unit,
wherein the processor is configured to set a reference ratio for a frame share ratio of a downlink data transmitted to the other terminal and an uplink data received from the other terminal and perform the device to device communication depending on the reference ratio.

13. The apparatus of claim 12, wherein the processor is configured to divide a frame in a time division scheme and the frame is composed of 10 sub-frames to divide between the downlink data and the uplink data.

14. The apparatus of claim 12, wherein the processor is configured to repeatedly use at least any one reference ratio of 2:3, 3:2, 4:1, 1:4, 7:3, 3:7, 8:2, 2:8, 9:1, 1:9, 3:3:2:2, 5:5, 3:3:2:2, 2:2:3:3, 1:1:1:1:1:1:1:1:1:1, 2:2:2:2:1:1, 2:2:1:1:2:2, 1:1:2:2:2:2, 4:6, 6:4, 2:3:2:3, 3:2:3:2, 0:10, 10:0, 0:5, and 5:0 as a transmission ratio of the downlink data and the uplink data.

15. The apparatus of claim 12, wherein the processor is configured to designate a frequency division scheme, not a time division scheme, using one of codes used in the reference ratio and make the apparatus using the time division scheme use a reference ratio of 10:0 or 5:0 at the time of using the frequency division scheme.
